(19) United States
(12) Patent Application Publication
(10) Pub. No.: US 2025/0370720 A1
(43) Pub. Date: Dec. 4, 2025

(54) GENERATING FORMATTED REQUIREMENTS FROM PLAIN-TEXT REQUIREMENTS USING GENERATIVE AI TECHNIQUES

(71) Applicant: Honeywell International Inc., Charlotte, NC (US)

(72) Inventors: Riyaz Pallikkere Kunhamed, Bangalore (IN); R Jyothi Priya, Madurai (IN); Monika Agrawal, Banglore (IN)

(73) Assignee: Honeywell International Inc., Charlotte, NC (US)

(21) Appl. No.: 18/812,615

(22) Filed: Aug. 22, 2024

(30) Foreign Application Priority Data
Jun. 4, 2024 (IN) 202411043254

(51) Int. Cl. G06F 8/10; G06N 20/00

(52) U.S. Cl. CPC G06F 8/10; G06N 20/00

(57) ABSTRACT

Systems and methods for creating models for generating formatted requirements from plain-text requirements using generative AI techniques are described herein. In certain embodiments, a system includes a memory configured to store a requirements database comprising plain-text requirements and formatted requirements, wherein the formatted requirements are requirements associated with the plain-text requirements that are formatted to a standard. Further, the system includes one or more processors configured to execute computer-readable instructions that cause the one or more processors to create a generative model using the plain-text requirements and the formatted requirements in the requirements database, wherein the generative model is trained to generate additional formatted requirements from user-provided plain-text requirements.

### CROSS-REFERENCE TO RELATED APPLICATIONS

This application claims benefit of Indian Provisional Patent Application No. 202411043254 filed on Jun. 4, 2024, and titled “GENERATING FORMATTED REQUIREMENTS FROM PLAIN-TEXT REQUIREMENTS USING GENERATIVE AI TECHNIQUES”, the contents of which are incorporated herein in their entirety.

### BACKGROUND

Software development is a complex process that often requires the effort of multiple developers and involves the interests of multiple stakeholders. Identifying software requirements is critical in ensuring that the development effort efficiently achieves its intended goals. Typically, the developers will identify software requirements as concise statements that specify what a software system should do and the conditions it must satisfy to be accepted by stakeholders. When the software is complete, the stakeholders can then test the software to ensure that the software requirements are satisfied.

### SUMMARY

Systems and methods for creating models for generating formatted requirements from plain-text requirements using generative AI techniques are described herein. In certain embodiments, a system includes a memory configured to store a requirements database comprising plain-text requirements and formatted requirements, wherein the formatted requirements are requirements associated with the plain-text requirements that are formatted to a standard. Further, the system includes one or more processors configured to execute computer-readable instructions that cause the one or more processors to create a generative model using the plain-text requirements and the formatted requirements in the requirements database, wherein the generative model is trained to generate additional formatted requirements from user-provided plain-text requirements.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a block diagram of a system for creating a generative model that generates formatted requirements from plain-text requirements according to an aspect of the present disclosure;

FIG. 2 is a block diagram illustrating the training of a generative model capable of producing formatted requirements from plain-text requirements according to an aspect of the present disclosure;

FIG. 3 is a flow chart diagram of a method for creating a generative model that generates formatted requirements from plain-text requirements according to an aspect of the present disclosure; and

FIG. 4 is a flow chart diagram of a method for creating and maintaining a generative model that generates formatted requirements from plain-text requirements according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods for generating formatted requirements from plain-text requirements using generative AI techniques are described herein. In particular, the systems and methods described herein can produce a model for generating formatted requirements from plain-text requirements according to industry standards. To create the generative model, a user may create a requirements database that includes plain-text software requirements and associated formatted requirements that conform to a desired industry standard. The data in the requirements database may be divided into different data sets. The different data sets may include training data, validation data, or testing data.

In certain embodiments, the training data may be used to train a machine learning model. In particular, the training data in the requirements database may be used to train a generative artificial intelligence model that can receive plain-text software requirements from a user and provide associated requirements formatted according to a standard. Further, training the model may include varying system (inputs) and system responses (expected outputs) for domain-specific terminologies to improve the accuracy of the trained model within certain software development domains. For purposes of this specification, “domain-specific” means that the terminology is specific to a particular technological field. For example, a domain may be technology and terminology generally used in aerospace, communication, defense, home automation, or any technological field that may incorporate unique or specific terminology. Further, the testing data in the requirements database may be used to test the generated model, and the validation data in the requirements database may be used to validate the generated model.

In some embodiments, when a generated model is trained, tested, and validated, the generated model may be deployed for use by others when generating formatted requirements that satisfy a particular standard. For example, software developers may draft plain-text requirements and provide them as inputs to the deployed model, where the deployed model generates equivalent requirements to the provided plain-text requirements that are formatted according to a desired standard. In some implementations, plain-text requirements provided as input to the deployed model, generated formatted requirements, and changes made to the generated formatted requirements can be saved and provided to the computation device that generated the deployed model for further training of the model to improve the performance of the generated models further.

Software requirements form a critical part of software development. For example, requirements define the scope and direction of software development efforts, contribute to allocating resources during software development, provide measured aims for testing and validating developed software, and determine whether developed software meets contractual agreements. Thus, requirements are a foundational component of software development, influencing every stage of the development process.

Due to the importance of software requirements, the software requirements must be as unambiguous as possible. When requirements are ambiguous, developers may produce software that fails to meet customers' expectations; projects can overrun budgets; software testing and change tracking become more difficult; and other problems arise in the software lifecycle. Therefore, clarity in requirements is critical. However, developers often write requirements in inherently ambiguous human language. Thus, a challenge in drafting requirements is the production of unambiguous requirements using ambiguous language.

The inherent ambiguity in human language is often addressed using various industry methodologies to ensure that produced requirements are unambiguous. Requirements produced using these methodologies can provide efficient foundations for every stage of the software development process. Examples of methodologies for drafting efficient requirements are the “constrained language enhanced approach to requirements” (CLEAR) and “easy approach to requirements syntax” (EARS). Following CLEAR, EARS, or other methodologies reduces ambiguity and facilitates the automated implementation and testing of the drafted requirements. However, converting plain-text requirements into the CLEAR/EARS format requires training and effort to understand the specific grammar supported by the methodologies and additional effort to ensure that the plain-text requirements are accurately mapped to requirements that satisfy the CLEAR/EARS methodologies.

In certain embodiments, machine learning models can generate formatted requirements from plain-text requirements that are formatted to satisfy an industry methodology like CLEAR or EARS. For example, a trained user may create a dataset that can be used to create a generative machine-learning model that receives plain-text requirements as input and outputs equivalent formatted requirements that satisfy a desired methodology. To create the dataset, a user or users trained in the desired methodology may draft formatted requirements from plain-text requirements. The combination of plain-text requirements and user-translated formatted requirements may then be used to train, validate, and test a machine-learning model. When trained, tested, and validated, the machine learning model may be deployed to increase the efficiency of requirements generation within software development efforts.

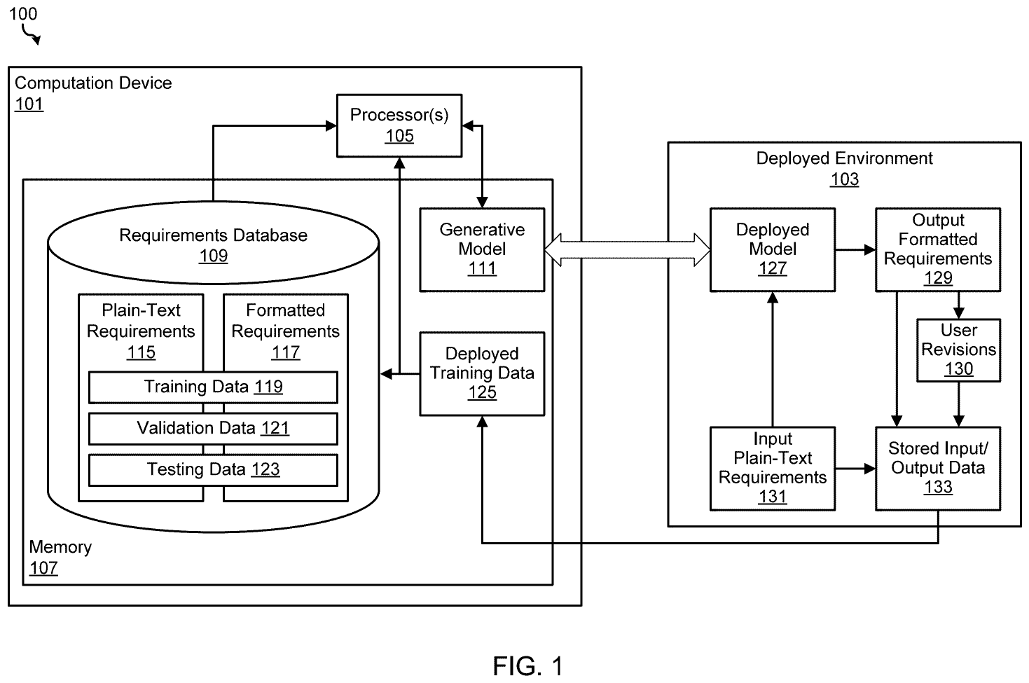

FIG. 1 is a block diagram of a system 100 for generating machine learning models for converting plain-text software requirements into formatted software requirements. As shown, the system 100 may include a computation device 101 that produces a generative model 111 for deployment as a deployed model 127 for use within a deployed environment 103. The computation device 101 may include one or more processors 105 and a memory 107, where the processors 105 process data within the memory 107 to create the generative model 111.

In some embodiments, the one or more processors 105 may be a combination of computation devices that can execute instructions that direct the one or more processors 105 to create, train, and maintain the generative model 111. The one or more processors 105 may be a single processor or a device that includes combinations of general-purpose processors, multi-core processors, multiple processors, dedicated circuitry, a graphics processing unit, and the like. The functions performed by the processors 105 may be implemented using software, firmware, hardware, or any appropriate combination thereof. The processors 105 and other computational devices may be supplemented by, or incorporated in, specially-designed application-specific integrated circuits (ASICs) or field programmable gate arrays (FPGAs). The processors 105 and other computational devices can also include or function with software programs, firmware, or other computer-readable instructions for performing various process tasks, calculations, and control functions used in the present methods and systems.

The present methods may be implemented by computer-executable instructions, such as program modules or components executed by the processor 105 or other computational devices. Generally, program modules include routines, programs, objects, data components, data structures, algorithms, and the like, which perform particular tasks or implement particular abstract data types.

In addition to the processors 105, the computation device 101 may include a memory 107. The memory 107 may store data used to train, test, and validate the generative model 111 along with storing the generative model 111. Further, the memory 107 may be any suitable computer-readable storage media that includes, for example, non-volatile memory devices, including semiconductor memory devices such as random access memory (RAM), read-only memory (ROM), electrically erasable programmable ROM (EEPROM), or flash memory devices; magnetic disks such as internal hard disks or removable disks; optical storage devices such as compact discs (CDs), digital versatile discs (DVDs), Blu-ray discs, or other media that can carry or store desired program code as computer-executable instructions or data structures.

In certain embodiments, the memory 107 may include a requirements database 109. As used herein, the requirements database 109 is a data structure within the memory 107 that stores requirements and other data used to create a generative model 111 that can convert plain-text requirements into formatted requirements. In particular, the requirements database 109 stores a set of plain-text requirements 115 and a set of formatted requirements 117, where each plain-text requirement in the plain-text requirements 115 has an associated formatted requirement in the formatted requirements 117. Further, a formatted requirement may be associated with one or more of the plain-text requirements 115.

In some embodiments, the plain-text requirements 115 may represent potential requirements typically written by a user that may or may not conform to an industry methodology. For example, a plain-text requirement may be initially drafted by a developer when creating software, a plain-text requirement may also describe a feature requested by a customer, and a plain-text requirement may be another requirement that a software product should satisfy. However, the plain-text requirements 115 are generally written in unstructured and unconstrained natural human language. The nature of human language may lead to imprecise, ambiguous, and inconsistent requirement statements or design details specified in the requirements. These problems with the plain-text requirements 115 may lead to difficulty with accurately implementing, testing, or verifying that the software satisfies the requirements or meets the original design goals for the software. While simple software designs may be developed using requirements drafted with natural language, the increasing complexity of software systems and the number of stakeholders in a single software product have led to the development of software requirement practices that can accurately and clearly capture the potential complexity of software development.

In some software development efforts, methodologies have been employed to overcome the limitations of natural human language that can lead to testable and unambiguous requirements. The Constrained Language Enhanced Approach to Requirements (CLEAR) and Easy Approach to Requirements Syntax (EARS) are examples of methodologies for adding details and refinements in sub-clauses of the requirements while providing formal syntax that is associated with semantics that support unambiguous interpretations, even when the requirements express complex behaviors.

When requirements are drafted using EARS, a user may follow a structured template for writing the requirements. In particular, EARS categorizes requirements based on their context and provides a template that can be followed based on the requirement category. These categories include ubiquitous, event-driven, unwanted-behavior, state-driven, and optional requirements. Ubiquitous requirements apply universally throughout a system and take the form, “The [system] shall [system response].” Event-driven requirements specify system behavior that should take place in response to some triggering event and take the form, “When [trigger], the [system] shall [system response].” Unwanted-behavior requirements specify the behavior of a system in response to undesired situations and take the form, “If [optional preconditions] [trigger], then the [system] shall [system response].” State-driven requirements specify system behavior that is dependent on a system state and take the form, “While [state], the [system] shall [system response].” Optional requirements specify optional features that may not always be present and take the form “Where [feature is included] the [system] shall [system response].” The templates for the different categories of requirements reduce the ambiguity of the claims.

CLEAR is based upon the requirement structure of EARS, defining multiple requirement types that include state/condition-driven, event-driven, abnormal behavior, optional feature, composite, and ubiquitous requirement types. In addition, the CLEAR limits a user to a subset of natural language to avoid ambiguity and complexity. For example, within CLEAR, a state/condition-driven requirement describes a behavior while a system is in a specific state and/or while a condition is satisfied and takes the general form “While [state/condition] [system response].” An event-driven requirement describes a behavior in response to an event trigger and takes the general form “When [event trigger] then [system response].” Further, in an event-driven requirement, CLEAR may require that certain verbs be used. An abnormal behavior requirement describes a system behavior in response to an abnormal or exception condition or event and takes the general form “If [state/condition/event], [system response].” Optional feature requirements describe a system behavior when an optional feature is included and take the general form “Where [feature], [system response].” Composite requirements describe behavior in response to combinations of states/conditions, events, optional features, and abnormal behaviors. The general form of composite requirements uses a restricted nesting of condition/event clauses using keywords: when, if, while, and where. Ubiquitous requirements describe an unconditional fundamental property of a system and take a general form that delineates the system response that is a fundamental property of the system.

Typically, when drafting requirements, the requirements are first drafted as plain-text requirements (such as those stored as plain-text requirements 115). Then a developer with knowledge of the EARS/CLEAR methodology, or other requirements formatting methodology, manually converts the plain-text requirements into a formalized requirement that follows the modeling approach. The manual conversion of plain-text requirements into a formalized requirement formatted according to a modeling approach is time-intensive and difficult to automate using traditional automation methods. Also, the manual conversion of plain-text requirements into the formatted requirements requires users familiar with the formatting methodologies.

In certain embodiments, the requirements database 109 may also store formatted requirements 117, which are formatted requirements that correspond to requirements in the plain-text requirements 115. The formatted requirements 117 have been formatted by a user or other computational device and are verified as conforming to a requirements methodology, such as CLEAR/EARS, with respect to an associated plain-text requirement stored in the plain-text requirements 115. For example, a plain-text requirement may state “The software will allow a user to log in using a username and a password. If the username or password is incorrect, an error message will be displayed to the user. If the user makes three unsuccessful attempts, the system will lock the user out for 15 minutes.” The above plain-text requirement may be formatted into multiple formatted requirements. For example, within EARS, a ubiquitous requirement derived from the above plain-text requirement may state “The system shall allow a user to log in using a username and a password,” an event-driven requirement derived from the above plain-text requirement may state “When the user enters an incorrect username or password, the system shall display an error message,” and an unwanted-behavior requirement derived from the above plain-text requirement may state “If the user makes three unsuccessful login attempts, the system shall lock the user's account for 15 minutes.” Accordingly, the formatted requirements 117 may divide complex, compound, or ambiguous requirements into clear statements that conform to constrained terminologies and formats.

In some embodiments, the plain-text requirements 115 and formatted requirements 117 include requirements drawn to a specific domain. For example, the plain-text requirements 115 and formatted requirements may be selected to reflect terminologies used in certain technological domains. Thus, when training the model the system inputs and system responses used to train the generative model 111 will reflect the terminology of the technological domain used within the plain-text requirements 115 and formatted requirements 117.

In further embodiments, both the plain-text requirements 115 and the formatted requirements 117 are preprocessed and organized into three different data groups used at different stages by the computation device when creating the generative model 111. For example, the plain-text requirements 115 and formatted requirements 117 can be separated into sets of training data 119, validation data 121, and testing data 123. In some implementations, a requirement may be in only one of the training data 119, validation data 121, and testing data 123. Alternatively, a requirement may be in more than one of the training data 119, validation data 121, and testing data 123.

As used herein, the training data 119 may refer to a dataset used by the computation device 101 to train the generative model 111. In particular, the training data 119 includes inputs (plain-text requirements 115) and desired model outputs (associated formatted requirements 117). When training a model, the inputs are provided to a modeling algorithm, which generates a predicted output. The modeling algorithm then compares the predicted output to the desired model outputs to identify a prediction error. The modeling algorithm then modifies the parameters of the model based on the identified prediction error. Thus, the computation device 101 uses the training data 119 to learn and fit the generative model 111 to ensure that the generative model 111 captures the necessary patterns to generate realistic outputs. Also, the training data 119 directly impacts the learned parameters of the generative model 111. Often, of the training data 119, validation data 121, and testing data 123, the training data 119 is the largest data set.

Further, the computation device 101 may use the validation data 121 to validate the generative model 111 trained using the training data 119. Validation of a model may be used to tune hyperparameters (parameters set before training to control the learning process and the behavior of the generative model 111 and to provide an unbiased evaluation of the generative model 111 during training). Often, the validation data 121 is unique from the training data 119. Also, the computation device 101 may periodically use the validation data 121 during training to help select a best model configuration and to detect overfitting. Thus, the computation device 101 uses the validation data 121 to tune hyperparameters and make decisions about the architecture of the generative model 111. Also, the validation data 121 may be used for early stopping to prevent overfitting of the generative model 111 to the training data 119. The validation data 121 may act as a checkpoint for model improvement during the generative model 111 training.

Additionally, the computation device 101 may use the testing data 123 to test the generative model 111. The testing of the generative model 111 produces an evaluation of the performance of the generative model 111 after the completion of model training. Typically, the testing data 123 is used to assess the performance of the generative model 111 using real-world data, often estimating the generalization capability of the generative model 111. Thus, the testing data 123 is used to evaluate the performance of the generative model 111 and provide an estimate of model generalization after training and validation of the generative model 111. Accordingly, the testing data 123 may confirm the ability of the generative model 111 to produce accurate and realistic outputs when presented with new data.

In certain embodiments, the computation device 101 creates the generative model 111 using the training data 119, validation data 121, and testing data 123. As the data used to create the generative model 111 includes plain-text requirements 115 as inputs that are checked against formatted requirements 117 as outputs, the generative model 111 can receive general plain-text requirements and generate formatted requirements that satisfy modeling approaches like EARS/CLEAR. As used herein, a generative model 111 refers to a class of models that can generate new data that resembles a given data set. The generative model 111 may also be referred to herein as a generative artificial intelligence (AI) model 111. The generative model 111 may learn underlying patterns and structures from training data and can produce new, synthetic data points using generative AI techniques. Examples of generative models include recurrent neural networks, long short-term memory networks, gated recurrent units, sequence-to-sequence models, transformers, variational autoencoders, autoregressive models, conditional generative models, large language models, and the like.

In further embodiments, after the generative model 111 is created by the computation device 101, the generative model 111 may be provided to a deployed environment 103 as a deployed model 127. Within the deployed environment 103, a software developer may use the deployed model 127 when drafting software requirements that can effectively be used in the software creation process. For example, a developer may draft or collect a set of plain-text requirements at the beginning of the software development process. This collection of plain-text requirements may serve as input plain-text requirements 131. The input plain-text requirements 131 are the collected plain-text requirements provided as input to the deployed model 127. The deployed model 127 then generates a set of output formatted requirements 129, which are the formatted versions of the input plain-text requirements that are formatted according to an industry methodology. The output formatted requirements 129 can be used throughout the software development lifecycle.

In some embodiments, the input plain-text requirements 131 and the output formatted requirements 129 may be stored within stored input/output data 133. Additionally, some of the requirements in the output formatted requirements 129 may be incorrect. As such, upon reviewing the output formatted requirements 129, a user may make revisions as necessary. The revisions may be collected as user revisions 130. Each revision in the user revisions 130 may be associated with the associated revised output formatted requirement and the input plain-text requirement that led to the generation of the output formatted requirement by the deployed model 127. The user revisions 130 may also be stored in the input/output data 133.

In certain embodiments, the computation device 101 may receive the stored input/output data from one or more deployed environments 103. For example, the deployed environment 103 may periodically transmit the stored input/output data 133 to the computation device 101. Alternatively, the deployed environment 103 may transmit the stored input/output data 133 to the computation device 101 in response to a request from the computation device 101. Further, the deployed environment 103 may transmit the stored input/output data 133 to the computation device 101 at the discretion of the deployed environment 103 or users associated with the deployed environment 103.

In further embodiments, upon reception of the stored input/output data 133 from a deployed environment 103, the computation device 101 may aggregate the received stored input/output data 133 from one or more deployed environments 103 as deployed training data 125. The deployed training data may be preprocessed and used to perform additional training of the generative model 111. In some implementations, the deployed training data 125 may be added to the requirements database 109. Within the requirements database 109, requirements from the deployed training data 125 may be added to either the plain-text requirements 115 or the formatted requirements 117 based on the type of requirement. Further, the deployed training data 125 may be used by users of the computation device to evaluate the ability of the generative model 111 to generate requirements that are appropriately formatted. Thus, the computation device 101 may use the deployed training data 125 to evaluate or update the generative model 111.

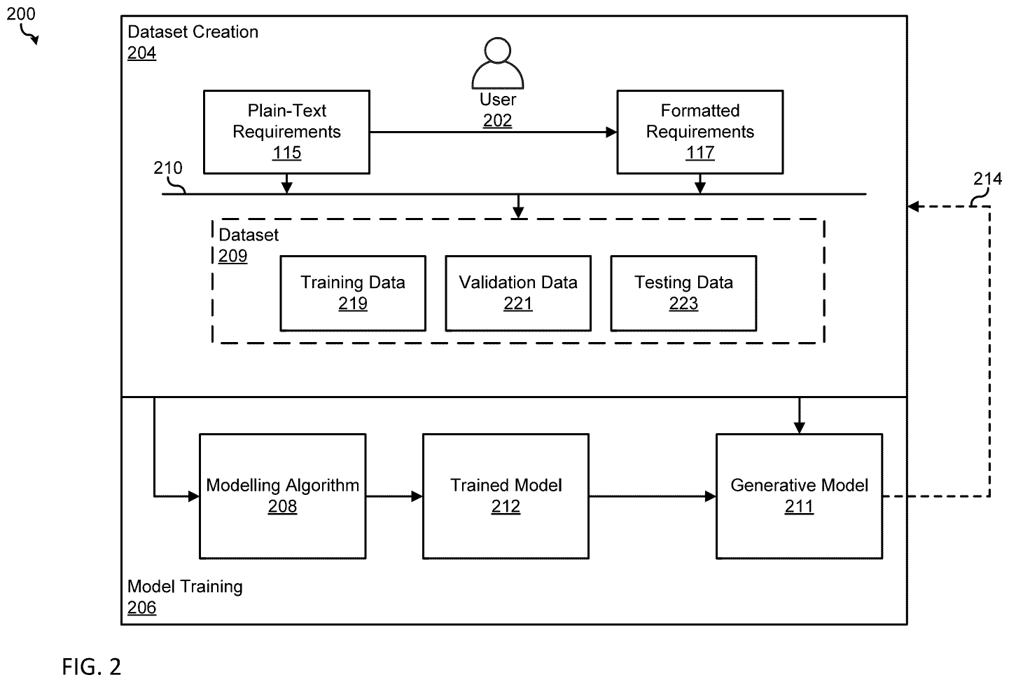

FIG. 2 is a block diagram illustrating a process 200 for creating a generative model 211 for generating formatted requirements from plain-text requirements from a dataset 209. As illustrated, the process 200 includes a dataset creation 204 and a model training 206. The dataset creation 204 refers to the process of assembling data and then preparing the data for training of the generative model 211. The model training 206 refers to the process of using the created dataset to train, test, and validate a deployable model that can be used to generate formatted software requirements when provided with plain-text requirements. Further, in some implementations, deployed model outputs 214 from a trained model may be used to provide additional data that can be used to enhance the dataset creation 204.

In certain embodiments, the dataset creation 204 may rely on input from one or more users 202 to assemble the dataset that will be used to train the generative model 211. Alternatively, the dataset can be automatically gathered from various sources that have produced data that can be used to train the generative model 211. As the assembled dataset includes plain-text requirements 115 and associated formatted requirements 117, as described above in connection with FIG. 1, one or more users 202 may create/assemble a large corpus of plain-text requirements 115 and associated formatted requirements 117. Alternatively, plain-text requirements 115 and associated formatted requirements 117 may be gathered from various sources, such as previously completed software development efforts. Essentially, one or more users 202 or an automated process may gather plain-text requirements 115 and associated formatted requirements 117 that can be used to train the generative model 211.

In further embodiments, the plain-text requirements 115 and the formatted requirements 117 gathered for training the generative model 211 may not be in a suitable form for training the generative model 211. Accordingly, the dataset creation 204 includes the step of preprocessing 210. The preprocessing 210 processes the assembled plain-text requirements 115 and formatted requirements 117 to be suitable as inputs within a dataset 209 for the training of machine learning models such as the training of the generative model 211 performed by model training 206. The preprocessing 210 may include various steps used by those with skill in the art of machine learning to prepare human provided text and other sources of potential training information for suitability as training inputs. For example, the preprocessing 210 may prepare the user assembled plain-text requirements 115 and formatted requirements 117 to be suitable for training the generative model 211. The preprocessing 210 may be performed by a combination of the user 202 and the processor 105 in FIG. 1. Examples of potential activities performed as part of the preprocessing 210 include cleaning the plain-text requirements 115 and formatted requirements 117 to ensure there are no repeated or erratic requirements in the plain-text requirements 115 and the formatted requirements 117. Also, the preprocessing 210 may include tokenizing the plain-text requirements 115 and formatted requirements 117, wherein text is split into smaller units like words, subwords, or characters. Additional activities performed in preprocessing 210 may include adding annotations to training data, creating sequences of training data, normalizing data, and other preprocessing activities employed within machine learning

In certain embodiments, when the plain-text requirements 115 and the formatted requirements 117 have been preprocessed 210 and are ready to be used as a dataset 209 for training the generative model 211, the dataset 209 may be split into different subsets of data that serve different purposes for training the generative model 211. In particular, the dataset 209 may be split into training data 219, testing data 223, and validation data 221. The training data 219, testing data 223, and validation data 221 are similar to the training data 119, validation data 121, and testing data 123 described above in connection with FIG. 1. In particular, the training data 219 is used to train the generative model 211, the validation data 221 is used to tune hyperparameters and avoid overfitting, and the testing data 223 is used to evaluate the performance of the trained generative model 211. The training data 219 is often the largest portion of the dataset 209.

In certain embodiments, when splitting the data in the dataset 209 into the training data 219, the validation data 221, and the testing data 223, the process 200 may employ several techniques that the user 202 may select based on the desired outcome. For example, the training data 219 is generally the largest data set, comprising up to 80% of the data used to create the generative model 211. The validation data 221 and the testing data 223 may comprise the balance of the data in the dataset 209. Often, the data in the dataset 209 can be randomly assigned to one of the training data 219, the validation data 221, and the testing data 223. Other techniques may be employed to divide the data, such as stratified sampling when trying to ensure that each group of data has the same distribution of classes, time-based splitting when it is desired that data within the validation data 221 and testing data 223 come from different time periods than the training data 219 to mimic time-dependent causal relationships. Additional splitting techniques may be employed to achieve certain aims based on the characteristics of the dataset. Also, when splitting the data into the training data 219 and the testing data 223, it is often important to ensure that the testing data 223 is unique from the training data 219 to ensure that testing data 223 is not represented within the model.

In additional embodiments, when the dataset 209 has been split into the training data 219, validation data 221, and testing data 223, the dataset 209 is ready to be used as inputs for the model training 206. The model training 206 may incorporate a modeling algorithm 208 that can produce generative models. As described above in connection with FIG. 1, the data associated with the plain-text requirements 115 within the training data 219 may be provided as inputs to the modeling algorithm 208, and the outputs from the modeling algorithm 208 may be compared against the data associated with the formatted requirements 117 in the training data 219. Based on the comparison, the modeling algorithm 208 adjusts parameters to create a trained model 212. After passing the training data 219 through the modeling algorithm 208, the model training 206 may use the validation data 221 and testing data 223 to validate and test the trained model 212 to create the generative model 211. Additionally, the modeling algorithm 208 may use the validation data 221 to validate the trained model 212 and the testing data 223 to test the validated the trained model 212 to create the generative model 211.

Accordingly, software developers may deploy the validated and trained generative model 211 to ensure that software requirements by software developers are less ambiguous, more traceable, and more testable. Thus, software developers can save time and effort by using the generative model 211 to generate formatted requirements while producing software that meets the associated requirements.

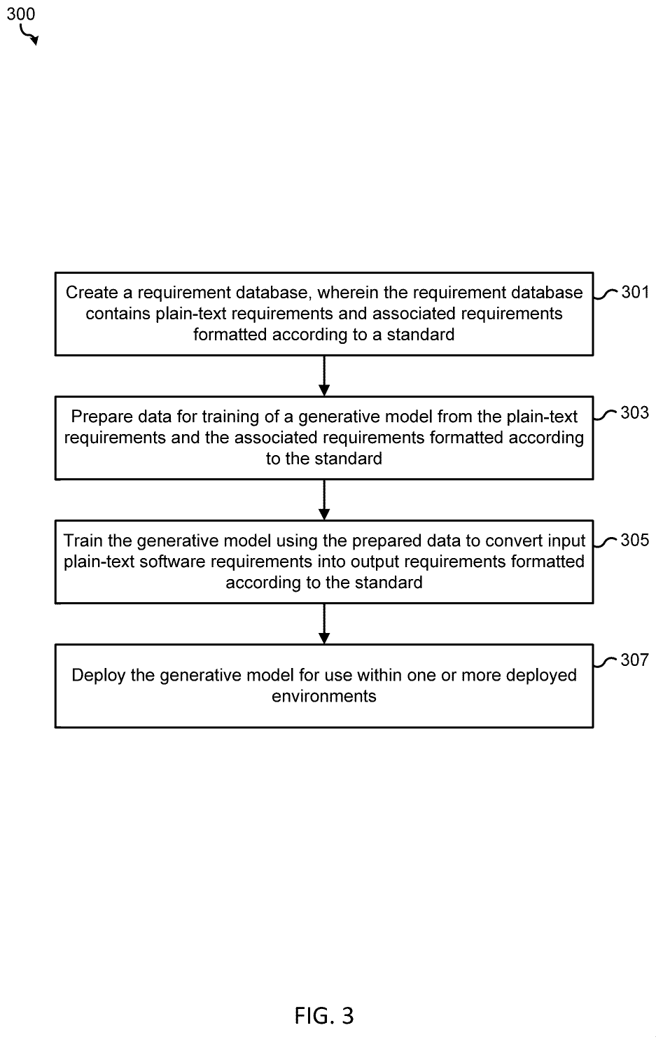

FIG. 3 is a flow chart diagram of a method 300 for creating a generative model that generates formatted requirements from plain-text requirements. The method 300 proceeds at 301, where a requirement database is created. The requirement database contains plain-text requirements and associated requirements formatted according to a standard. Further, the method 300 proceeds at 303, where data is prepared for training of a generative model from the plain-text requirements and the associated requirements formatted according to the standard. Additionally, the method 300 proceeds at 305, where the generative model is trained using the prepared data to convert input plain-text software requirements into output requirements formatted according to the standard. Moreover, the method 300 proceeds at 307, where the generative model is deployed for use within one or more deployed environments.

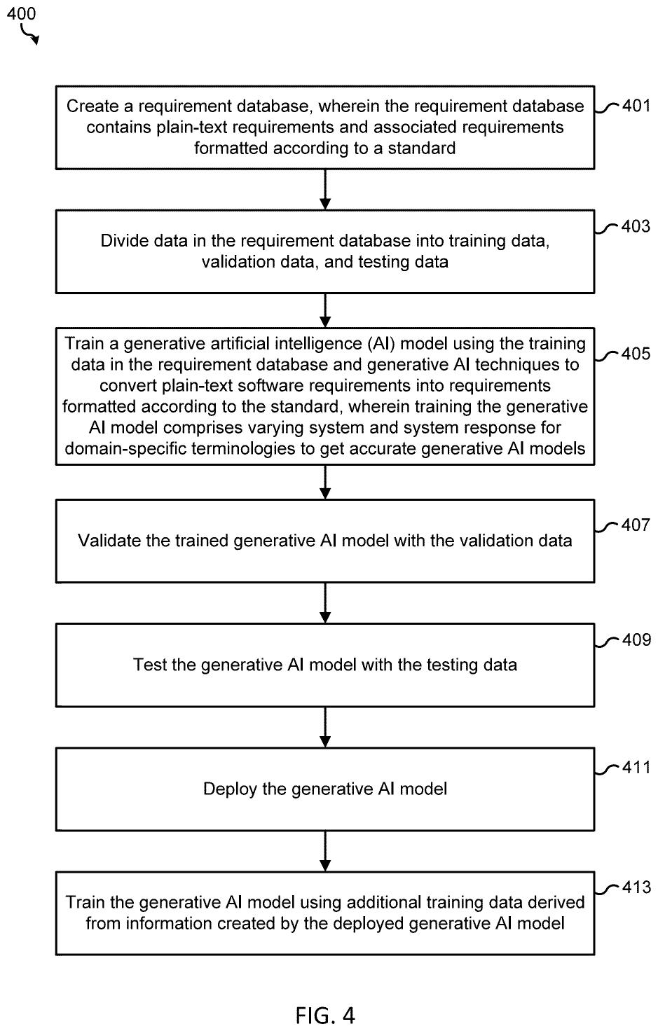

FIG. 4 is a flow chart diagram of a method 400 for creating and maintaining a generative model that generates formatted requirements from plain-text requirements. The method 400 proceeds at 401, where a requirement database is created. The requirement database contains plain-text requirements and associated requirements formatted according to a standard. Moreover, the method 400 proceeds at 403, where data in the requirement database is divided into training data, validation data, and testing data. Further, the method 400 proceeds at 405, where a generative AI model is trained using the training data in the requirement database and generative AI techniques to convert plain-text software requirements into requirements formatted according to the standard. Training the generative AI model comprises varying system and system response for domain-specific terminologies to get accurate generative AI models.

In certain embodiments, the method 400 proceeds at 407, where the trained generative AI model is validated with the validation data. Also, the method 400 proceeds at 409, where the generative AI model is tested with the testing data. Further, the method 400 proceeds at 411, where the generative AI model is deployed. Additionally, the method 400 proceeds at 413, where the generative AI model is trained using additional training data derived from information created by the deployed generative AI model.

### EXAMPLE EMBODIMENTS

Example 1 includes a system comprising: a memory configured to store a requirements database comprising plain-text requirements and formatted requirements, wherein the formatted requirements are requirements associated with the plain-text requirements that are formatted to a standard; and one or more processors configured to execute computer-readable instructions that cause the one or more processors to create a generative model using the plain-text requirements and the formatted requirements in the requirements database, wherein the generative model is trained to generate additional formatted requirements from user-provided plain-text requirements.

Example 2 includes the system of Example 1, wherein the plain-text requirements and the formatted requirements are arranged in sets comprised of training data, validation data, and testing data.

Example 3 includes the system of Example 2, wherein the one or more processors use the training data to train the generative model.

Example 4 includes the system of any of Examples 2-3, wherein the one or more processors use the validation data to validate the generative model.

Example 5 includes the system of any of Examples 2-4, wherein the one or more processors use the testing data to test the generative model.

Example 6 includes the system of any of Examples 2-5, wherein the plain-text requirements and the formatted requirements are preprocessed before being arranged into the training data, the validation data, and the testing data.

Example 7 includes the system of any of Examples 1-6, wherein the standard is at least one of: easy approach to requirements syntax (EARS); and constrained language enhanced approach to requirements (CLEAR).

Example 8 includes the system of any of Examples 1-7, wherein the memory stores deployed training data received from other systems that implemented the generative model within a deployed environment.

Example 9 includes the system of Example 8, wherein the deployed training data comprises at least one of: input plain-text requirements provided to the generative model within one or more deployed environments; output formatted requirement generated by the generative model within the one or more deployed environments; and revisions to the output formatted requirements made by users within the one or more deployed environments.

Example 10 includes the system of any of Examples 1-9, wherein the generative model is trained to generate additional formatted requirements that conform to domain-specific terminologies.

Example 11 includes a method comprising: creating a requirement database, wherein the requirement database contains plain-text requirements and associated requirements formatted according to a standard; preparing data for training of a generative model from the plain-text requirements and the associated requirements formatted according to the standard; training the generative model using the prepared data to convert input plain-text software requirements into output requirements formatted according to the standard; and deploying the generative model for use within one or more deployed environments.

Example 12 includes the method of Example 11, wherein the standard is at least one of: easy approach to requirements syntax (EARS); and constrained language enhanced approach to requirements (CLEAR).

Example 13 includes the method of any of Examples 11-12, wherein preparing the data for training of the generative model comprises: preprocessing the plain-text requirements and the associated requirements formatted according to the standard to create suitable data for training the generative model; and dividing the suitable data into training data, validation data, and testing data.

Example 14 includes the method of Example 13, further comprising: training the generative model with the training data; validating the generative model with the validation data; and testing the generative model with the testing data.

Example 15 includes the method of any of Examples 11-15 wherein training the generative model comprises varying system and system responses for domain-specific terminologies.

Example 16 includes the method of Example 11, further comprising receiving deployed training data from other systems that implemented the generative model within one or more deployed environments.

Example 17 includes the method of Example 16, wherein the deployed training data comprises at least one of: input plain-text requirements provided to the generative model within the one or more deployed environments; output formatted requirement generated by the generative model within the one or more deployed environments; and revisions to the output formatted requirements made by users within the one or more deployed environments.

Example 18 includes the method of any of Examples 16-17, further comprising performing additional training of the generative model using the deployed training data.

Example 19 includes a method comprising: creating a requirement database, wherein the requirement database contains plain-text software requirements and associated requirements formatted according to a standard; dividing data in the requirement database into training data, validation data, and testing data; training a generative artificial intelligence (AI) model using the training data in the requirement database and generative artificial intelligence techniques to convert plain-text software requirements into requirements formatted according to the standard, wherein training the generative AI model comprises varying system and system response for domain-specific terminologies to get accurate generative AI models; validating the trained generative AI model with the validation data; testing the generative AI model with the testing data; deploying the generative AI model; and training the generative AI model using additional training data derived from information created by the deployed generative AI model.

Example 20 includes the method of Example 19, wherein the standard is at least one of: easy approach to requirements syntax (EARS); and constrained language enhanced approach to requirements (CLEAR).

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a memory configured to store a requirements database comprising plain-text requirements and formatted requirements, wherein the formatted requirements are requirements associated with the plain-text requirements that are formatted to a standard; and
one or more processors configured to execute computer-readable instructions that cause the one or more processors to create a generative model using the plain-text requirements and the formatted requirements in the requirements database, wherein the generative model is trained to generate additional formatted requirements from user-provided plain-text requirements.

2. The system of claim 1, wherein the plain-text requirements and the formatted requirements are arranged in sets comprised of training data, validation data, and testing data.

3. The system of claim 2, wherein the one or more processors use the training data to train the generative model.

4. The system of claim 2, wherein the one or more processors use the validation data to validate the generative model.

5. The system of claim 2, wherein the one or more processors use the testing data to test the generative model.

6. The system of claim 2, wherein the plain-text requirements and the formatted requirements are preprocessed before being arranged into the training data, the validation data, and the testing data.

7. The system of claim 1, wherein the standard is at least one of:
easy approach to requirements syntax (EARS); and
constrained language enhanced approach to requirements (CLEAR).

8. The system of claim 1, wherein the memory stores deployed training data received from other systems that implemented the generative model within a deployed environment.

9. The system of claim 8, wherein the deployed training data comprises at least one of:
input plain-text requirements provided to the generative model within one or more deployed environments;
output formatted requirement generated by the generative model within the one or more deployed environments; and
revisions to the output formatted requirements made by users within the one or more deployed environments.

10. The system of claim 1, wherein the generative model is trained to generate additional formatted requirements that conform to domain-specific terminologies.

11. A method comprising:
creating a requirement database, wherein the requirement database contains plain-text requirements and associated requirements formatted according to a standard;
preparing data for training of a generative model from the plain-text requirements and the associated requirements formatted according to the standard;
training the generative model using the prepared data to convert input plain-text software requirements into output requirements formatted according to the standard; and
deploying the generative model for use within one or more deployed environments.

12. The method of claim 11, wherein the standard is at least one of:
easy approach to requirements syntax (EARS); and
constrained language enhanced approach to requirements (CLEAR).

13. The method of claim 11, wherein preparing the data for training of the generative model comprises:
preprocessing the plain-text requirements and the associated requirements formatted according to the standard to create suitable data for training the generative model; and
dividing the suitable data into training data, validation data, and testing data.

14. The method of claim 13, further comprising:
training the generative model with the training data;
validating the generative model with the validation data; and
testing the generative model with the testing data.

15. The method of claim 11 wherein training the generative model comprises varying system and system responses for domain-specific terminologies.

16. The method of claim 11, further comprising receiving deployed training data from other systems that implemented the generative model within one or more deployed environments.

17. The method of claim 16, wherein the deployed training data comprises at least one of:
input plain-text requirements provided to the generative model within the one or more deployed environments;
output formatted requirement generated by the generative model within the one or more deployed environments; and
revisions to the output formatted requirements made by users within the one or more deployed environments.

18. The method of claim 16, further comprising performing additional training of the generative model using the deployed training data.

19. A method comprising:
creating a requirement database, wherein the requirement database contains plain-text software requirements and associated requirements formatted according to a standard;
dividing data in the requirement database into training data, validation data, and testing data;
training a generative artificial intelligence (AI) model using the training data in the requirement database and generative artificial intelligence techniques to convert plain-text software requirements into requirements formatted according to the standard, wherein training the generative AI model comprises varying system and system response for domain-specific terminologies to get accurate generative AI models;
validating the trained generative AI model with the validation data;
testing the generative AI model with the testing data;
deploying the generative AI model; and
training the generative AI model using additional training data derived from information created by the deployed generative AI model.

20. The method of claim 19, wherein the standard is at least one of:
easy approach to requirements syntax (EARS); and
constrained language enhanced approach to requirements (CLEAR).
